(19) United States
(12) Patent Application Publication
(10) Pub. No.: US 2019/0254257 A1
(43) Pub. Date: Aug. 22, 2019

(54) Chewable pet toy with indestructible housing for electronic components

(71) Applicant: Lucas Dean Alm, Washington, DC (US)

(72) Inventor: Lucas Dean Alm, Washington, DC (US)

(21) Appl. No.: 16/280,389

(22) Filed: Feb. 20, 2019

Related U.S. Application Data
(60) Provisional application No. 62/633,323, filed on Feb. 21, 2018.

(51) Int. Cl. A01K 15/02

(52) U.S. Cl. CPC A01K 15/025

(57) ABSTRACT

A device by which electronic components such as a sound maker, motion sensor, battery, or time delay can be incorporated safely into a chewable dog toy by encasing them in a sound-permeable, indestructible housing which is safe for creatures and resistant to wear.

### CROSS-REFERENCE TO RELATED APPLICATIONS

### U.S. Provisional Patent Application No. 62/633,323

### Filing Date: Feb. 21, 2018

### Applicant: Lucas Dean Alm, Washington, D.C.

Title: Chewable pet toy with indestructible housing for electronic components

### BACKGROUND OF THE INVENTION

### Field of the Invention

The field of the invention is animal toys generally, and more specifically chewable dog toys.

### SUMMARY OF PRIOR ART

Chewable dog toys are known, and many of these toys include a mechanical squeaker which is activated by the bite force of a dog.

This presents a few disadvantages: first, mechanical squeakers may not be fully activated by dogs with a light bite force; second, mechanical squeakers may not be activated by dogs with small mouths; third, mechanical squeakers are only activated when the dog bites area over the mechanical squeaker and bites on other parts of the toy do not create a squeak; finally, mechanical squeakers are not activated during other forms of play such as nudging, pawing, tossing, or dropping.

These shortcomings are overcome by the invention.

Cat toys with electronic squeakers exist. But these toys are not suitable to dogs or animals with a strong bite force and often carry warnings that they are dangerous to dogs. This is because the bite force of a dog is enough to break most electronic components rendering the components sharp and dangerous.

### BRIEF SUMMARY OF THE INVENTION

The invention contains electronic components inside of a sound-permeable, indestructible housing which can then be placed inside of a chewable toy such as one made of fabric and stuffing. The electronic components can include a motion sensor and sound maker. This can allow noise making upon a variety of conditions beyond the bite force of an animal—such as nudging, pawing, tossing, or dropping.

The use of an indestructible housing enables innovations in the field of electronics to be safely, easily, and durably applied to the field of chewable dog toys. For example, an apparatus with a motion sensor, time delay, and sound maker can cause a sound to be made after a dog has ceased to play with the toy, and thus regain the dog's attention and stimulate more play.

### BRIEF DESCRIPTION OF THE SEVERAL VIEWS OF THE DRAWING

FIG. 1 is a side view of a stuffed toy with the area described by the dotted line cut out so that the interior of the toy, including the indestructible housing, can be seen.

FIG. 2 is a view of the housing with electronic components extracted.

FIG. 3 is a view of the housing with the electronic components housed therein.

FIG. 4 is a view of the housing and two halves of an organizing body which can hold electronic parts and components and prevent them from moving significantly during insertion and use.

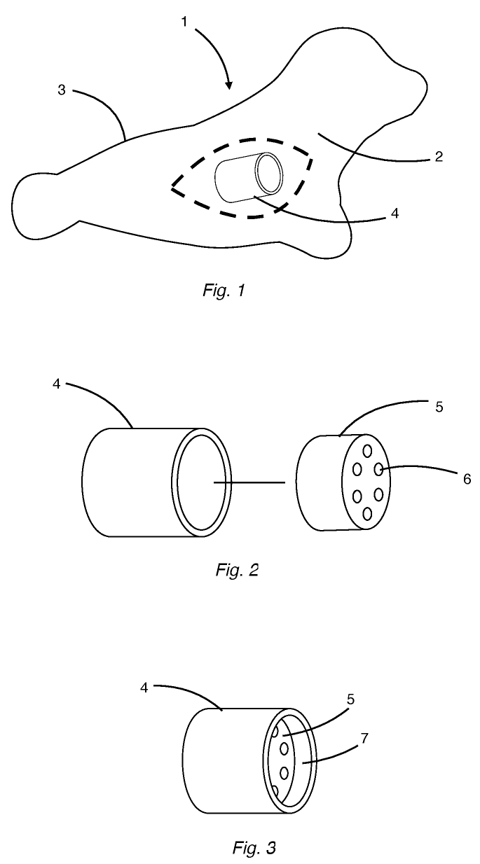

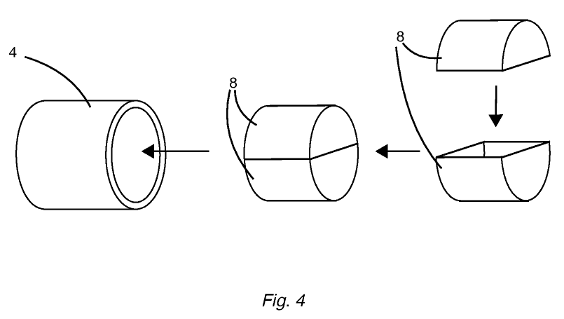

### DETAILED DESCRIPTION OF THE INVENTION

In the suggested embodiment, a chewable pet toy 1 is made of a fabric exterior 3 and stuffing 2 and contains the housing 4.

The housing 4 is made to contain a set of electronic components 5 which can include holes 6 to allow sound to permeate. This configuration can be made to house a wide variety of electronic components which are not pictured, including: battery, speaker, motion sensor, timer, circuit board, sound chip, and other common components.

The housing 4 benefits from a strong material with some flexibility and a hardness lower than that of canine teeth is preferable—for example, PVC.

The housing 4 benefits from a geometric shape that is capable of withstanding strong compressing force. This can be cylindrically shaped with a hollow core to hold the electronic components—for example, a shape like a common coupling for a three-quarters inch schedule forty PVC plastic pipe.

It is advisable that the housing 4 have a length that is longer than the diameter. In this configuration, the bite will commonly fall across the narrowest cross section, which will be the round portion. This is less straining to teeth or gums.

The ends of the housing 4 can be left open to allow the device to be sound-permeable. Or they can be covered by a thin membrane to allow it to be sound-permeable but also waterproof.

A housing 4 of cylindrical shape with hollow core can be implemented in a single molded piece that does not rely on joints or fasteners, which are prone to wear. It is a property of all housings that have a hollow core whose cross-section is the same across the length of the hollow core that the protected components can be inserted therein and held in place with epoxy or snap fasteners without the need for additional separate parts of a housing to hold them in place.

The ends of the housing 4 can also be made so that they constitute a protrusion 7 past the electrical components 5 that they cover so that if a dog's tooth enters the housing through an open end, it may not be able to reach and damage the electronic components.

Electronic components using a motion sensor, battery, and sound maker can be used so that when the toy is moved the sound maker is activated. This can include a sound of more than one high-pitched tone at once including sounds beyond the human hearing range or a variety of sounds, which can be more stimulating to an animal.

This can also include a time-delay so that when an animal has ceased to play with the toy, some time passes and then the toy makes an additional sound thus regaining the animal's attention and stimulating more play.

A surprising result was discovered during the use of this invention. When the housing contained electronic components that were configured to make an attention-getting noise when undergoing a change in g-force, such as being dropped or swung, and then when the animal grew tired of the toy and dropped it and it hit the ground and the toy made the noise, the noise often regained the attention of the animal and play resumed. This invention therefore enables a superior method of entertaining animals, whereby they are given a toy that makes an attention-getting noise when the toy is dropped.

An indestructible housing may benefit from being made of a hard material. This presents a problem that the hardness of the housing may damage an animal's teeth during vigorous chewing. This problem can be solved and the housing can be made safe for creatures by use of an elastic or rubber coating, matrix, or structure around the housing which disperses or absorbs the chewing force and protects the teeth from damage by the housing. Alternatively, the housing itself can be made of a material that is sufficiently soft to not harm teeth. Thus, the housing can be made safe for creatures.

This problem is also helped by surrounding the housing with a fabric material and stuffing which can partially disperse chewing force, but a thick elastic structure is preferable for this purpose.

Wall thicknesses of the housing can vary widely. Preferentially, wall thicknesses are between 1 and 10 mm, although thickness may vary more on either side. 3.5 mm works well for applications for dogs.

Housing size is also an important factor in resisting the bite force of an animal. The housing must be large enough to hold the desired components. But for most shapes (for example a sphere), as the size of the housing increases, then the strain on walls and angles increases, despite compressive force being held constant. A volume of between 3 cubic cm and 1,000 cubic cm is recommended. Preferentially, the smallest possible embodiment may be used. Housings with a volume of 1,000 cubic cm will require substantially thicker walls and more supporting material to resist the same bite force as a smaller embodiment.

It is beneficial to prevent the inner components and electronic parts from moving significantly during use. This helps to prevent circuits from being interrupted unintentionally or strain from being placed on non-structural parts—such as soldered connections. It is also beneficial to hold internal components and electronic parts together while they are being placed inside the housing during assembly—so that that assembly task is simplified. To accomplish this, an organizing body can be used. The organizing body can hold the electronic parts and other internal components still and steady while the electronic parts, other internal components, and the organizing body are placed inside of the housing. A recommended embodiment of an organizing body is two halves 8 which encapsulates parts, which are combined together and are inserted into a unibody housing 4. This same organizing body can hold the parts and components steady later while the device is subjected to vigorous movement during play with an animal.

Alternatively, the housing can contain protrusions, indentations, or ridges to which these components can be attached directly or against which these components can be pressed so that they are prevented from significantly moving. This may allow similar results to the use of an organizing body distinct from the housing.

The useful embodiments of this invention are not limited to the housing when contained in a fabric toy, but can include the housing when contained in any number of useful materials or structures. These embodiments allow the invention to benefit many types of toys—such as balls, throwable discs, and imitation bones—which are known to be loved by dogs. These alternative embodiments include: the housing when contained in an elastic structure, the housing when contained in a hard structure—such as a throwable disc or imitation bone—the housing when contained in a ball, or the housing when the housing itself forms the outside surface of the chewable toy—such as in the case of an imitation bone.

### Definitions

The term “aperture” here means: an opening, hole, or gap.

The term “chewable” here means: can be safely chewed without destruction by an animal such as a dog.

The term “elastic” here means: able to resume its normal shape after contraction, dilatation, or distortion.

The term “hard structure” here means: a structure that is not elastic.

The term “indestructible” here means: is not normally destroyed by the bite force of an ordinary dog during an ordinary play session.

The term “matrix” here means: material in which something is enclosed or embedded.

The term “membrane” here means: a wall that is thin enough to allow the passage of sound.

The term “organizing body” here means: a structure that organizes or holds components in a manner that prevents them from significantly moving.

The term “protective outer body” here means: a structure which protects internal parts against external forces, such as compressive force.

The term “sound-permeable” here means: having at least one element such as an aperture or a membrane which allow the passage of sound.

The term “safe for creatures” here means: having a reduced likelihood that a creature will be harmed by the use of the item—for example, by cuts from components that have broken and become sharp or by damage to the creature's tooth from biting against a hard substance.

The term “unibody” here means: consisting of a continuous substance, an example is a single molded piece 4.

1. A pet toy including an indestructible housing which encompasses inner components or electronic parts.

2. The invention of claim 1: where said indestructible housing is made to be sound-permeable by means of one or more aperture or membranes.

3. The invention of claim 1: where a substantial portion of the indestructible housing is comprised of at least one unibody element.

4. The invention of claim 2: where a substantial portion of the indestructible housing is comprised of at least one unibody element.

5. The invention of claim 1: which includes one or more inner organizing bodies along with one or more protective outer bodies.

6. The invention of claim 1: where the housing contains protrusions which prevent inner components or electronic parts from significantly moving.

7. The invention of claim 1: where the housing contains protrusions, indentations, or ridges to which components or electronic parts can be affixed.

8. The invention of claim 1: where the housing is made safe for creatures by means of an elastic coating, matrix, or structure outside of said housing.

9. The invention of claim 1: where the housing is made safe for creatures by itself being made of a sufficiently elastic substance to reduce the risk of harm to teeth.

10. The invention of claim 1: where one or more time-delayed noises are used.

11. The invention of claim 1: where the electronic components produce a noise in the ultrasonic range.

12. The invention of claim 1: where the electronic parts make more than one tone.

13. The invention of claim 1: where the wall thickness of the housing is between 1 mm and 10 mm.

14. The invention of claim 1: where the outer perimeter of the housing encompasses a volume of between 3 cubic cm and 1,000 cubic cm.

15. The invention of claim 1: where the housing is contained in a fabric material.

16. The invention of claim 1: where the housing is contained in a hard structure which forms the outer surface.

17. The invention of claim 1: where the housing is contained in a ball.

18. The invention of claim 1: where the housing itself forms the outside surface of the toy.

19. The invention of claim 1: where the electronic parts are configured so that the toy makes a noise when it undergoes a change in g-force.

20. A method of entertaining animals consisting of: providing the animal with a device that makes an attention-getting noise when it undergoes a change in g-force, such as when it is dropped or swung.
